(19) United States
(12) Patent Application Publication
(10) Pub. No.: US 2010/0253983 A1
(43) Pub. Date: Oct. 7, 2010

(54) IMAGE READING APPARATUS AND CONTROLLING DEVICE THEREOF, PROGRAM, AND CONTROLLING METHOD

(75) Inventors: Koh Hong Bin, Singapore (SG); Sanda Win, Singapore (SG)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/752,050

(22) Filed: Mar. 31, 2010

(30) Foreign Application Priority Data
Apr. 2, 2009 (JP) 2009-090305

(51) Int. Cl. H04N 1/04

(52) U.S. Cl. 358/475

(57) ABSTRACT

Provided is a controlling device for controlling an image reading apparatus that optically reads an original, which includes a lighting controlling section that controls a first lighting section and a second lighting section which are the first and second lighting sections provided in the image reading apparatus, form each of the linear light emitting regions, and irradiate the original with light from directions intersecting with each other, and the lighting controlling section includes a first mode unit that controls the first and second lighting sections in a first mode in which one of the first and second lighting sections irradiates the original, a second mode unit that controls the first and second lighting sections in a second mode in which both of the first and second lighting sections irradiate the original.

### BACKGROUND

1. Technical Field

The present invention relates to an image reading apparatus (image scanner) that optically reads an original.

2. Related Art

As an image reading apparatus, there is known an apparatus which generates image data obtained by optically reading an original in a way that a linear light emitting region is formed, the original is irradiated with light from one direction, and light reflected from the original is read (JP-A-2009-27467). In such an image reading apparatus, since the original is irradiated with light from one direction, it is possible to suppress blurriness in an image caused by light irregularly reflected on the surface of the original (flare) and to read the original vividly.

However, in the image reading apparatus in the related art, because the original can be read clearly, when an original with wrinkles or with irregular surface is read, there is a problem in that even the wrinkles or irregularities are unnecessarily read.

### SUMMARY

An advantage of some aspects of the invention is that it provides a technique with which the surface shape of an original can be read as under desired conditions.

The invention aims at solving at least part of the above problem, and can be realized as embodiments or applications described below.

### Application 1

According to Application 1 of the invention, there is provided a controlling device for controlling an image reading apparatus that optically reads an original, which includes a lighting controlling section that controls a first lighting section and a second lighting section which are the first and second lighting sections provided in the image reading apparatus, form each of the linear light emitting regions, and irradiate the original with light from directions intersecting with each other. The lighting controlling section includes a first mode unit that controls the first and second lighting sections in a first mode in which one of the first and second lighting sections irradiates the original, a second mode unit that controls the first and second lighting sections in a second mode in which both of the first and second lighting sections irradiate the original, and a mode selecting unit that selects any one of the first mode or second mode based on an instruction input from a user when the original is optically read. According to the controlling device of Application 1, it is possible to adjust the influence of the surface shape in the original on the read image by switching the condition of lighting irradiating the original as the user desires. As a result, it is possible to read wrinkled or irregular surface shape in the original under desired conditions.

### Application 2

According to Application 1 of the invention, there is provided a controlling device in which the mode selecting unit further includes a preceding reading section that acquires a preceding image obtained by optically reading the original in the second mode before the mode selecting unit selects any one of the first mode or second mode, and a first user interface that presents the preceding image to a user and receives an instruction input from the user for selecting any one of the first mode or second mode. According to the controlling device of Application 2, the user can select a mode with reference to the preceding image obtained by reducing the influence of the surface shape of the original.

### Application 3

According to Application 1 or 2 of the invention, there is provided a controlling device in which the mode selecting unit further includes a second user interface that receives an instruction input from the user for adjusting at least one of an amount of light emitted from each of the first and second lighting sections, and division of light distributed in light emitting regions in each of the first and second lighting sections. According to the controlling device of Application 3, the user can adjust the influence of the surface shape of the original on a captured image.

### Application 4

According to any one of Applications 1 to 3 of the invention, there is provided a controlling device in which the mode selecting unit further includes a third user interface that presents a sample image expected when the original is optically read in each of the first and second modes to the user. According to the controlling device of Application 4, the user can select a mode comparing the sample images in each of the modes with each other.

### Application 5

According to Application 5 of the invention, there is provided an image reading apparatus for optically reading an original, which includes first and second lighting sections that form each of the linear light emitting regions and irradiate the original with light from directions intersecting with each other, and a lighting controlling section that controls the first and second lighting sections. The lighting controlling section includes a first mode unit that controls the first and second lighting sections in a first mode in which one of the first and second lighting sections irradiates the original, a second mode unit that controls the first and second lighting sections in a second mode in which both of the first and second lighting sections irradiate the original, and a mode selecting unit that selects any one of the first mode or second mode based on an instruction input from a user when the original is optically read. According to the image reading apparatus of Application 5, it is possible to adjust the influence of the surface shape of the original on the read image by switching the condition of lighting irradiating the original as the user wants. As a result, it is possible to read wrinkled or irregular surface shapes in the original under desired conditions.

### Application 6

According to Application 6 of the invention, there is provided a program which causes a computer to realize a function of controlling an image reading apparatus that optically reads an original and a lighting controlling function of controlling a first lighting section and a second lighting section which are first and second lighting sections provided in the image reading apparatus, form each of the linear light emitting regions, and irradiate the original with light from directions intersecting with each other. The lighting controlling function includes functions of controlling the first and second lighting sections in a first mode in which one of the first and second lighting sections irradiates the original, controlling the first and second lighting sections in a second mode in which both of the first and second lighting sections irradiate the original, and selecting any one of the first and second modes based on an instruction input from a user when the original is optically read. According to the image reading apparatus of Application 6, it is possible to adjust the influence of the surface shape of the original on the read image by switching the condition of lighting irradiating the original as the user wants. As a result, it is possible to read wrinkled or irregular surface shape in the original under desired conditions.

### Application 7

According to Application 7 of the invention, there is provided a controlling method for controlling an image reading apparatus that optically reads an original, which includes a lighting controlling process by a computer which controls a first lighting section and a second lighting section that are the first and second lighting sections provided in the image reading apparatus, form each of the linear light emitting regions, and irradiate the original with light from directions intersecting with each other. The lighting controlling process includes selecting any one of a first mode in which one of the first and second lighting sections irradiates the original or a second mode in which both of the first and second lighting sections irradiate the original based on an instruction input from a user. According to the controlling method of Application 7, it is possible to adjust the influence of the surface shape of the original on the read image by switching the condition of lighting irradiating the original as the user wants. As a result, it is possible to read wrinkled or irregular surface shape in the original under desired conditions.

An embodiment of the invention is not limited to the controlling device, the image reading apparatus, the program, and the controlling method, and can be applied to other embodiments. In addition, the invention is not limited to embodiments described above, and can be implemented in various forms within the scope not departing from the gist of the invention.

### BRIEF DESCRIPTION OF THE DRAWINGS

The invention will be described with reference to the accompanying drawings, wherein like numbers reference like elements.

FIG. 1 is an explanatory diagram illustrating a structure of an external appearance of an image reading system.

FIG. 2 is an explanatory diagram schematically illustrating an internal structure of an image scanner.

FIG. 3 is a partial cross-sectional view illustrating a detailed structure of a lighting device.

FIG. 4 is an exploded perspective view illustrating a detailed structure of the lighting device.

FIG. 5 is an explanatory diagram illustrating a detailed structure of a personal computer in the image reading system.

FIG. 6 is a flowchart illustrating an image reading controlling process executed by the personal computer of the image reading system.

FIG. 7 is an explanatory diagram illustrating an example of GUI presented to a user in a mode designation receiving process.

FIG. 8 is a flowchart illustrating an image reading controlling process executed by a personal computer of an image reading system in a first modified example.

FIG. 9 is an explanatory diagram illustrating an example of GUI presented to a user in a mode designation receiving process in the first modified example.

FIG. 10 is a flowchart illustrating an image reading controlling process executed by a personal computer of an image reading system in a second modified example.

FIG. 11 is an explanatory diagram illustrating an example of GUI presented to a user in a mode designation receiving process in the second modified example.

FIG. 12 is an explanatory diagram illustrating an example of GUI presented to a user in a mode process receiving process.

### DESCRIPTION OF EXEMPLARY EMBODIMENTS

Hereinafter, an image reading system to which the invention is applied will be described in order to further clarify the structure and action of the invention described above.

### A. Embodiment

### A1. The Structure of the Image Reading System

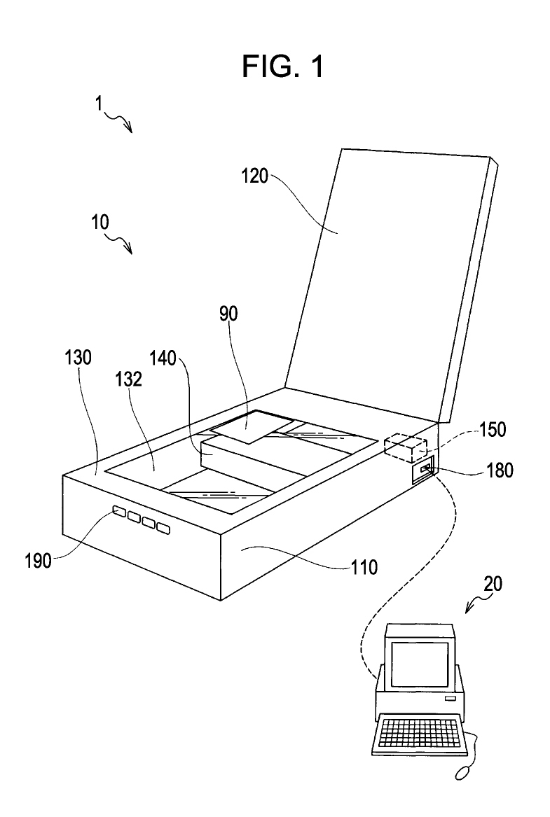

FIG. 1 is an explanatory diagram illustrating a structure of an external appearance of an image reading system 1. The image reading system 1 is a system that generates image data based on an original 90. The image reading system 1 is provided with an image scanner 10 and a personal computer 20.

The image scanner 10 of the image reading system 1 is a flat bed type image reading apparatus, and generates image data by optically reading the original 90. The image scanner 10 is provided with a body housing 110, a lid body 120, an original platen 130, an image reading section 140, a main controlling section 150, a device interface 180, and a user interface 190.

The body housing 110 of the image scanner 10 accommodates the image reading section 140. In this embodiment, the body housing 110 is a box in a rectangular shape.

The original platen 130 of the image scanner 10 is provided in the body housing 110, configured to form a flat surface for placing the original 90 thereon, and is provided with a transparent section 132 formed of a transparent material. In this embodiment, the original platen 130 is provided on the upper surface of the body housing 110, and the transparent section 132 of the original platen 130 is a piece of colorless and transparent glass in a rectangular shape smaller than the upper surface of the body housing 110.

The lid body 120 of the image scanner 10 is a lid openable and closable in the upper direction of the original platen 130, and provided in the body housing 110. In this embodiment, the lid body 120 has a shape larger than that of the transparent section 132 of the original platen 130, and is pivotally attached to the body housing 110.

The image reading section 140 of the image scanner 10 scans and optically reads an original placed on the transparent section 132 of the original platen 130 and generates image data expressing the document. The structure of the image reading section 140 will be described in detail later.

The device interface 180 of the image scanner 10 performs the exchange of information between the person computer 20. In this embodiment, the device interface 180 is an interface based on the Universal Serial Bus (USB) standard, but in other embodiments, may be an interface connected to the personal computer 20 via a network.

A user interface 190 of the image scanner 10 performs the exchange of information between a user who uses the image scanner 10. In this embodiment, the user interface 190 is provided with manipulation buttons for receiving manipulation input from the user, but in other embodiments, may be further provided with an image display section for displaying various kinds of information toward the user.

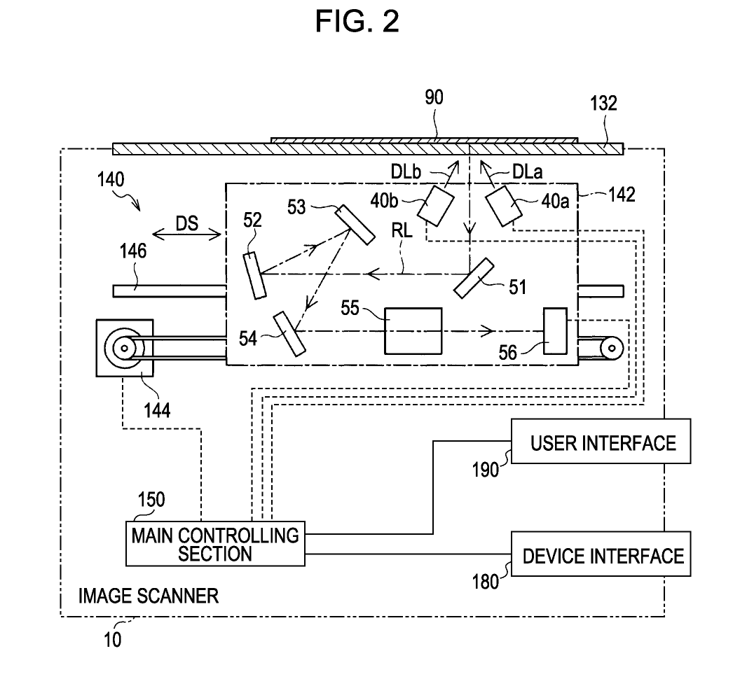

FIG. 2 is an explanatory diagram schematically illustrating an internal structure of the image scanner 10. The image reading section 140 of the image scanner 10 is provided with a carriage 142, a conveyance mechanism section 144, and a guide shaft 146.

The carriage 142 of the image reading section 140 is mounted with various kinds of constituent parts for optically reading the original 90, and is a reciprocating base reciprocating with respect to the original 90 along the scanning direction DS. The guide shaft 146 of the image reading section 140 is a shaft placed along the scanning direction DS, and supports the carriage 142 reciprocating along the scanning direction DS.

The conveyance mechanism section 144 of the image reading section 140 is a mechanism causing the carriage 142 to move with respect to the original 90 along the scanning direction DS based on the instruction of the main controlling section 150. In this embodiment, the conveyance mechanism section 144 is a belt-driven type conveying mechanism provided with a driving motor, a timing belt, a pulley, and the like.

The image reading section 140 is provided with lighting devices 40a and 40b, reflection mirrors 51, 52, 53, and 54, a lens unit 55, and an image-capturing device 56 as various constituent parts mounted in the carriage 142.

The lighting devices 40a and 40b of the image reading section 140 each form linear light emitting regions based on the instruction of the main controlling section 150, and are a first and a second lighting sections for radiating light to the original 90 from directions DLa and DLb intersecting with each other. As shown in FIG. 2, the direction DLa of light radiated from the lighting device 40a intersects with the direction DLb of light radiated from the lighting device 40b, and the light radiated from each of the lighting devices 40a and 40b is radiated at the substantially same position in a read plane of the original 90.

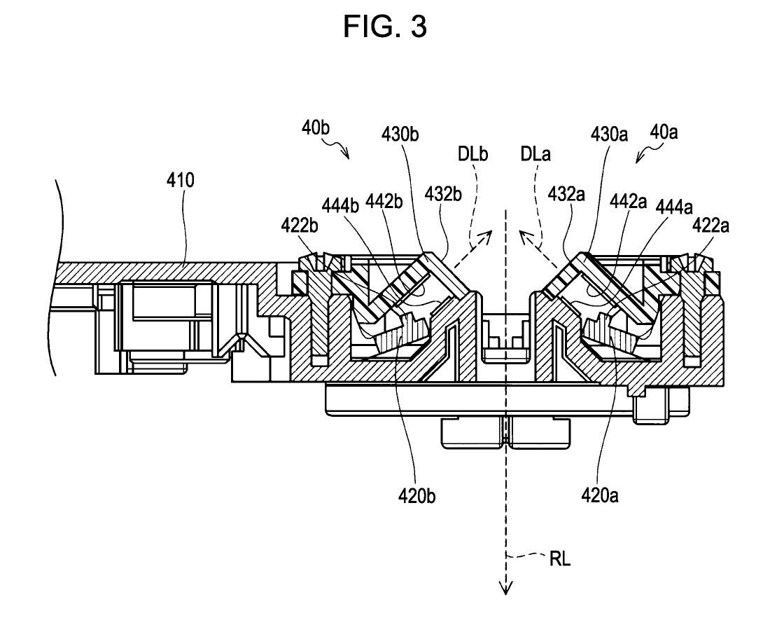

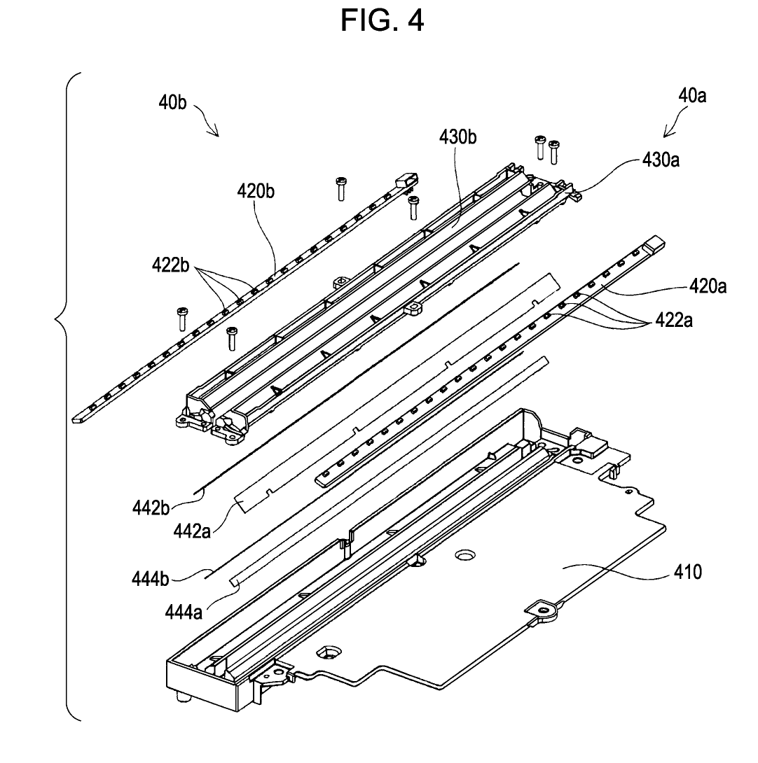

FIG. 3 is a partial cross-sectional view illustrating detailed structure of the lighting devices 40a and 40b. FIG. 4 is an exploded perspective view illustrating detailed structure of the lighting devices 40a and 40b. The lighting devices 40a and 40b are provided in a lighting housing 410 constituting a part of the carriage 142. The lighting device 40a is provided with a light emitting substrate 420a, a diffuser 430a, and reflectors 442a and 444a.

The light emitting substrate 420a of the lighting device 40a is a printed substrate in an elongated shape with a plurality of light emitting elements 422a mounted thereon in an arranged manner. In this embodiment, the light emitting elements 422a are light emitting diodes (LEDs) emitting white light, but in other embodiments, other light sources may be used. In this embodiment, the light emitting substrate 420a is mounted with 20 light emitting elements 422a by being arranged in a row, but in other embodiments, the number of the light emitting elements 422a may be changed, and the light emitting elements 422a may be mounted by being arranged in 2 or more rows.

The diffuser 430a of the lighting device 40a is formed of a transparent or milky white synthetic resin in an elongated shape, and formed with a light diffusing member that diffuses light emitted from the plurality of light emitting elements 422a on the light emitting substrate 420a and releases the light to the original 90. The diffuser 430a is provided with a long surface 432a, which is elongated, along the arrangement of the plurality of light emitting elements 422a, and forms a linear light emitting region by releasing light from the long surface 432a.

The reflectors 442a and 444a of the lighting device 40a are light reflecting members reflecting light emitted from the light emitting elements 422a on the light emitting substrate 420a onto the long surface 432a of the diffuser 430a. In this embodiment, the reflectors 442a and 444a are made of synthetic resin subjected to plating, but in other embodiments, a metal plate or a mirror may be used.

The structure of the lighting device 40b is the same as the lighting device 40a except that the lighting device 40b is opposed to the lighting device 40a, which is a line symmetric structure with the lighting device 40a, as shown in FIG. 3. In addition, in the present specification and drawings, each reference numeral of each member constituting the lighting device 40b is switched from “a” to “b” in reference numerals attached to the corresponding members of the lighting device 40a.

Returning back to the description of FIG. 2, the reflection mirrors 51, 52, 53, and 54 of the image reading section 140 reflect light reflected from the original 90 to the lens unit 55. The lens unit 55 of the image reading section 140 is provided with a plurality of lenses arranged in a row, and makes light reflected from the reflection mirror 54 form an image in the image-capturing device 56. The image-capturing device 56 of the image reading section 140 converts the reflected light of which an image is formed by the lens unit 55 into an electric signal based on the instruction of the main controlling section 150. In this embodiment, the image-capturing device 56 is provided with a charge coupled device (CCD) as an imaging device, but in other embodiments, other imaging devices including a complementary metal oxide semiconductor (CMOS) may be used. In this embodiment, a path RL of the reflected light reaching the image-capturing device 56 from the original 90 passes through between the lighting devices 40a and 40b, and then reaches the lens unit 55 via the reflection mirrors 51, 52, 53, and 54 in that order.

The main controlling section 150 of the image scanner 10 is electrically connected to each sections including the image reading section 140, the device interface 180, and the user interface 190 in the image scanner 10, and controls those sections. Specifically, the main controlling section 150 performs lighting control for controlling lighting of each of the lighting devices 40a and 40b, conveying control for controlling the drive of the conveyance mechanism section 144, and image-capturing control for controlling image-capturing of the image-capturing device 56. In this embodiment, the main controlling section 150 is capable of communicating with the personal computer 20 via the device interface 180, and performs various kinds of control process based on the instruction from the personal computer 20.

When the original 90 is read in the image scanner 10, the main controlling section 150 moves the carriage 142 in the scanning direction DS, and acquires an electric signal from the image-capturing device 56 at an interval synchronized with the movement of the carriage 142 in the state where at least one of the lighting devices 40a and 40b is turned on. After that, the main controlling section 150 generates image data based on the electric signal from the image-capturing device 56. Then, the main controlling section 150 transmits the image data to the personal computer 20 through the device interface 180.

In this embodiment, the functions of the main controlling section 150 are realized by the operation of a central processing unit (hereinafter, referred to as “CPU”) based on software, but in other embodiments, the functions may be realized by an electronic circuit of the main controlling section 150 operating based on the physical circuit structure.

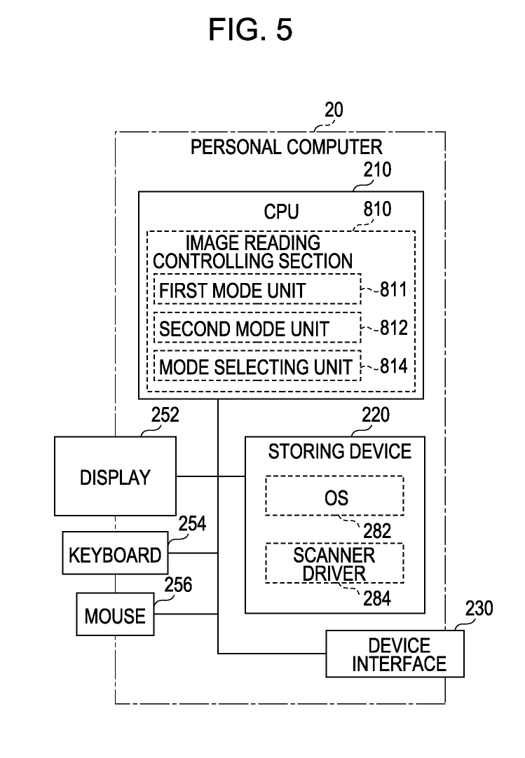

FIG. 5 is an explanatory diagram illustrating a detailed structure of the personal computer 20 in the image reading system 1. The personal computer 20 is provided with a CPU 210, a storing device 220, a device interface 230, a display 252, a keyboard 254, and a mouse 256.

In the personal computer 20, the CPU 210 executes various kinds of arithmetic process based on programs stored in the storing device 220, and the storing device 220 stores data processed by the CPU 210. The programs stored in the storing device 220 include an operating system (OS) 282 and a scanner driver 284 as an application program. The scanner driver 284 is a program for realizing the function of controlling the image scanner 10 in the CPU 210, and the personal computer 20 functions as a controlling device for controlling the image scanner 10 by the CPU 210 operating based on the scanner driver 284.

The personal computer 20 is provided with an image reading controlling section 810 as a function realized by the CPU 210 operating based on the scanner driver 284. The image reading controlling section 810 controls the operation of the image scanner 10 via the device interface 230, and operates as a lighting controlling section for controlling the lighting devices 40a and 40b. The image reading controlling section 810 is provided with a first mode unit 811, a second mode unit 812, and a mode selecting unit 814.

The first mode unit 811 of the image reading controlling section 810 controls the lighting devices 40a and 40b in a “1-line lighting mode” which is a first mode for irradiating the original 90 with one of the lighting devices 40a and 40b. The second mode unit 812 of the image reading controlling section 810 controls the lighting devices 40a and 40b in a “2-line lighting mode” which is a second mode for irradiating the original 90 with both of the lighting devices 40a and 40b. The mode selecting unit 814 of the image reading controlling section 810 selects one of the 1-line lighting mode and the 2-line lighting mode based on the instruction input from the user when the original 90 is optically read.

The device interface 230 of the personal computer 20 performs the exchange of information between the image scanner 10. In this embodiment, the device interface 230 is an interface based on the universal serial bus (USB) standard, but in other embodiments, the device interface may be an interface connected to the image scanner 10 via a network.

The display 252 of the personal computer 20 is a user interface for displaying an image toward the user. The keyboard 254 and the mouse 256 of the personal computer 20 are user interfaces for receiving the instruction input from the user.

### A2. Operation of Image Reading System

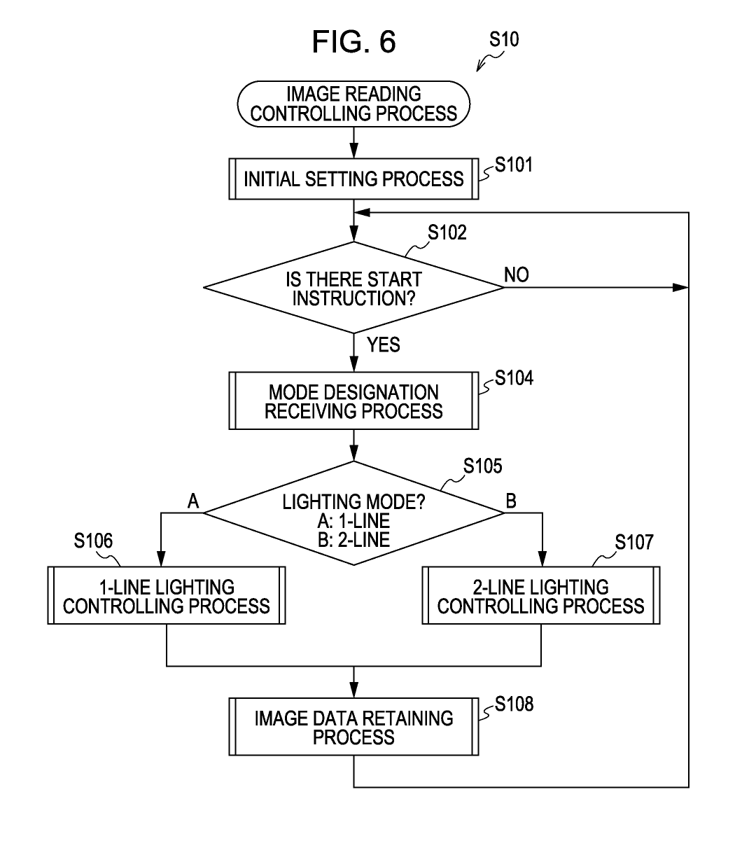

FIG. 6 is a flowchart illustrating an image reading controlling process (Step S10) executed by the personal computer 20 of the image reading system 1. The image reading controlling process (Step S10) is a process of controlling the operation of the image scanner 10. In this embodiment, the personal computer 20 executes the image reading controlling process (Step S10) by the CPU 210 operating as the image reading controlling section 810 based on the scanner driver 284.

When the image reading controlling process (Step S10) is started, the personal computer 20 executes an initial setting process (Step 5101) for establishing the connection to the image scanner 10.

After the initial setting process (Step S101), the personal computer 20 determines whether there is a start instruction indicating the start of reading of the original 90 (Step S 102). In this embodiment, after the user arranges the original 90 on the original platen 130 of the image scanner 10, the personal computer 20 determines whether there is a start instruction based on an instruction input to the user interface 190 of the image scanner 10.

When there is the start instruction (Step S 102: “YES”), the personal computer 20 executes a mode designation receiving process (Step S 104). In the mode designation receiving process (Step S104), the personal computer 20 receives designation from the user by which mode the original 90 is to be read between the 1-line lighting mode and the 2-line lighting mode. In this embodiment, in the mode designation receiving process (Step S 104), the personal computer 20 receives designation of a mode from the user through a graphical user interface (hereinafter, referred to as a “GUI”).

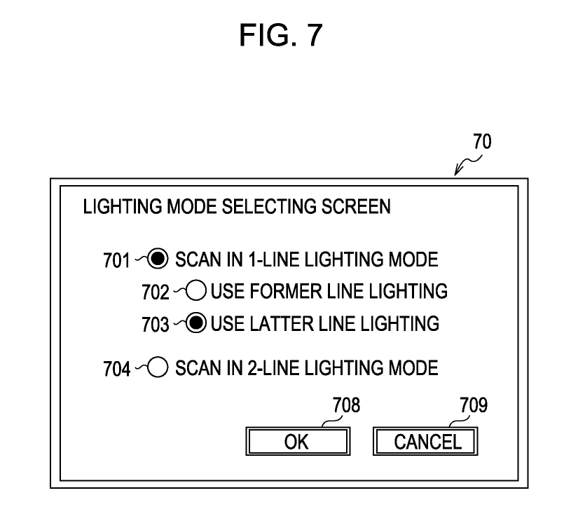

FIG. 7 is an explanatory diagram illustrating an example of a GUI 70 presented to the user in the mode designation receiving process (Step S 104). In the personal computer 20, the GUI 70 is displayed on the display 252, and receives the instruction input from the user through the mouse 256. The GUI 70 is provided with input buttons 701, 702, 703, and 704, an execution button 708, and a cancel button 709. In this embodiment, the input buttons 701, 702, 703, and 704 are switched into black circles or white circles by clicking them with the mouse 256, and the black circles represent a selected state and the white circles represent a non-selected state.

The input button 701 of the GUI 70 is a user interface receiving the designation of the 1-line lighting mode from the user, and the input button 704 of the GUI 70 is a user interface receiving the designation of the 2-line lighting mode from the user. One of input buttons 701 and 704 are set to be selected in the 1-line lighting mode or the 2-line lighting mode so that one of the buttons turns into a black circle and the other one turns into a white circle.

The input button 702 of the GUI 70 is a user interface receiving the designation of the lighting device 40a which is a former line lighting from the user when the 1-line lighting mode is selected, and the input button 703 of the GUI 70 is a user interface receiving the designation of the lighting device 40b which is a latter line lighting from the user when the 1-line lighting mode is selected. The input buttons 702 and 703 are activated when the input button 701 for the 1-line lighting mode is selected, and one of the lighting devices 40a and 40b is set to be selected so that one of the button turns into a black circle and the other one turns into a white circle.

The execution button 708 of the GUI 70 is a user interface receiving an instruction input for confirming the state of each of the input buttons from the user, and the cancel button 709 of the GUI 70 is a user interface receiving an instruction input for cancelling the reading of the original 90 from the user. For example, if the execution button 708 is clicked with the mouse 256 in the state shown in FIG. 7, reading of the original 90 in the 1-line lighting mode is performed using the lighting device 40b.

Returning to the description of FIG. 6, after the mode designation receiving process (Step S104), the personal computer 20 selects (Step S105) any one of the 1-line lighting mode and the 2-line lighting mode based on the instruction input from the user in the mode designation receiving process (Step S 104) by the CPU 210 operating as the mode selecting unit 814. In this embodiment, when the selection of the input button 701 is confirmed in the GUI 70, the 1-line lighting mode is selected, and when the selection of the input button 704 is confirmed in the GUI 70, the 2-line lighting mode is selected. In this embodiment, when the selection of the input button 702 is confirmed in the GUI 70, the 1-line lighting mode using the lighting device 40a is selected, and when the selection of the input button 703 is confirmed in the GUI 70, the 1-line lighting mode using the lighting device 40b is selected.

When the 1-line lighting mode is selected (Step S105: “A”), the personal computer 20 executes a 1-line lighting controlling process (Step S106) by the CPU 210 operating as the first mode unit 811. In the 1-line lighting controlling process (Step S106), the personal computer 20 controls the lighting devices 40a and 40b to be in the 1-line lighting mode in which the original 90 is irradiated with one of the lighting devices 40a and 40b.

On the other hand, when the 2-line lighting mode is selected (Step S 105: “B”), the personal computer 20 executes a 2-line lighting controlling process (Step S 107) by the CPU 210 operating as the second mode unit 812. In the 2-line lighting controlling process (Step S 107), the personal computer 20 controls the lighting devices 40a and 40b to be in the 2-line lighting mode in which the original 90 is irradiated with both of the lighting devices 40a and 40b.

In this embodiment, in the 1-line lighting controlling process (Step 5106) and the 2-line lighting controlling process (Step S 107), the personal computer 20 transmits control data for controlling the lighting devices 40a and 40b in each of the lighting modes to the image scanner 10 through the device interface 230. After that, the main controlling section 150 of the image scanner 10 performs reading of the original 90 based on the control data received from the personal computer 20 and transmits image data generated in the reading to the personal computer 20.

After the 1-line lighting controlling process (Step S 106) and the 2-line lighting controlling process (Step S 107), the personal computer 20 executes an image data retaining process (Step S108). In this embodiment, the personal computer 20 retains the image data received from the image scanner 10 in the storing device 220 in the image data retaining process (Step S 108). After the image data retaining process (Step S 108), the personal computer 20 repeatedly executes the image reading controlling process (Step S10) from the process (Step S 102) for determining whether there is a start instruction.

### A3. Effect

According to the image reading system 1 described above, it is possible to adjust the influence of the surface shape in the original 90 on the read image by switching the mode of lighting by the lighting devices 40a and 40b irradiating the original 90 as the user wants. As a result, it is possible to read wrinkled or irregular surface shape in the original 90 under desired conditions.

For example, when the original 90 is a document, it is possible to suppress blurriness by flare in a boundary portion (edge) between characters and a margin by reading the original 90 in the 1-line lighting mode in which the original 90 is irradiated with one of the lighting devices 40a and 40b. In addition, when the material feeling or the texture of the original 90 is expressed by an image, it is possible to reflect the irregularities of the original 90 on the read image by reading the original 90 in the 1-line lighting mode.

Furthermore, when the original 90 is a photograph printed in a mat photo paper, it is possible to suppress the matt pattern from being included in the read image by reading the original 90 in the 2-line lighting mode in which the original 90 is irradiated with both of the lighting devices 40a and 40b. In addition, when the original 90 is three-dimensional by overlapping a plurality of papers, it is possible to suppress a shade from being included in the read image by reading the original 90 in the 2-line lighting mode in which the original 90 is irradiated with both of the lighting devices 40a and 40b. In addition, when the original 90 is wrinkled, it is possible to suppress the wrinkles from being included in the read image by reading the original 90 in the 2-line lighting mode in which the original 90 is irradiated with both of the lighting devices 40a and 40b.

### B. Modified Example

### B1. First Modified Example

The structure of an image reading system 1 according to a first modified example is the same as the embodiment described above. The operation of the image reading system 1 according the first modified example is the same as that in the embodiment described above except that the image reading controlling process executed by the personal computer 20 is different from each other.

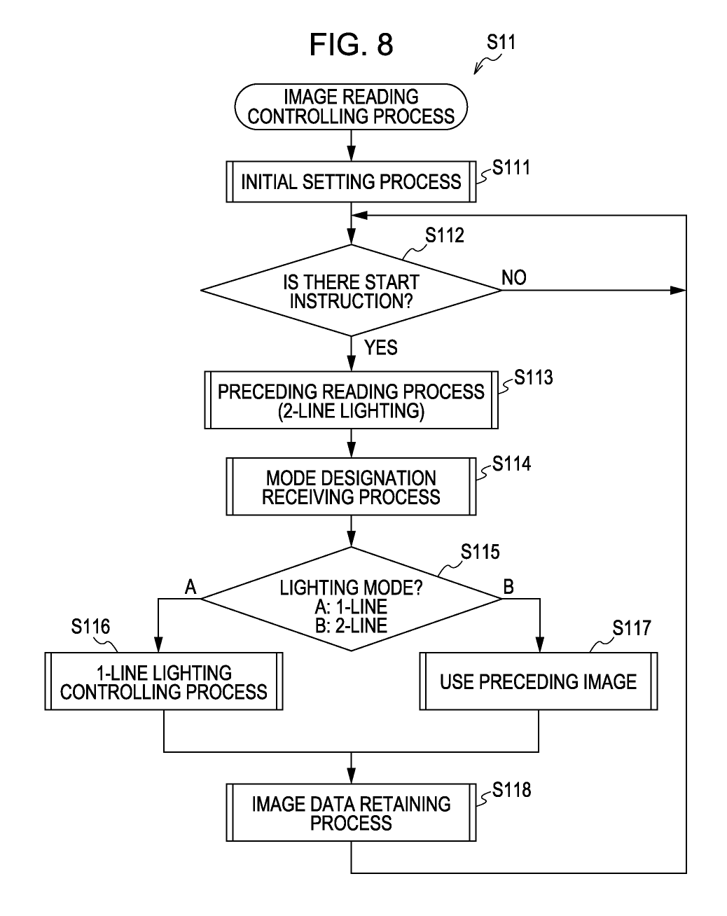

FIG. 8 is a flowchart illustrating an image reading controlling process (Step S11) executed by the personal computer 20 of the image reading system 1 according to the first modified example. The image reading controlling process (Step S11) is a process of controlling the operation of the image scanner 10. In this example, the personal computer 20 executes the image reading controlling process (Step S11) by the CPU 210 operating as the image reading controlling section 810 based on the scanner driver 284.

If the image reading controlling process (Step S11) is started, the personal computer 20 executes an initial setting process (Step S111) for establishing the connection to the image scanner 10. After the initial setting process (Step S111), the personal computer 20 determines whether there is a start instruction indicating the start of reading of the original 90 (Step S112).

When there is a start instruction (Step S 112: “YES”), the personal computer 20 executes a preceding reading process (Step S 113) for acquiring a preceding image obtained by optically reading the original 90 in the 2-line lighting mode. In the preceding reading process (Step S113), the personal computer 20 transmits control data to the image scanner 10 for controlling the lighting devices 40a and 40b to turn to the 2-line lighting mode through the device interface 230 in order to control the lighting devices 40a and 40b to be in the 2-line lighting mode in which the original 90 is irradiated with both of the lighting devices 40a and 40b. After that, the main controlling section 150 of the image scanner 10 performs reading of the original 90 based on the control data received from the personal computer 20 and transmits image data generated in the reading to the personal computer 20. Then, the personal computer 20 processes an image as a preceding image based on the image data.

After the preceding reading process (Step S113), the personal computer 20 executes a mode designation receiving process (Step S114). In the mode designation receiving process (Step S114), the personal computer 20 receives designation by which mode the original 90 is to be read between the 1-line lighting mode and the 2-line lighting mode from a user. In this example, in the mode designation receiving process (Step S114), the personal computer 20 receives the designation of mode from the user through the GUI.

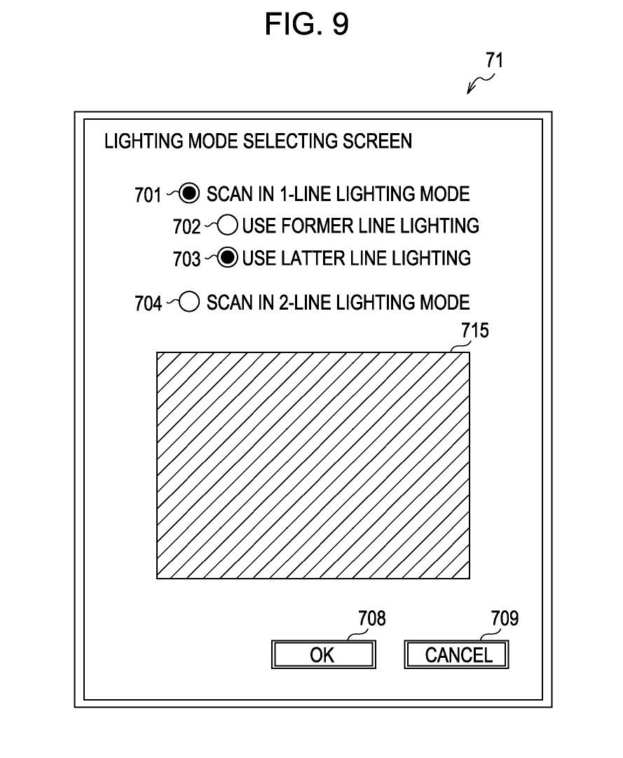

FIG. 9 is an explanatory diagram illustrating an example of a GUI 71 presented to the user in the mode designation receiving process (Step S 114) according to the first modified example. The GUI 71 in the first modified example is the same as the GUI 70 in the embodiment described above except that there is provided a preceding image display section 715 for displaying the preceding image acquired in the preceding reading process (Step S 113). The preceding image display section 715 of the GUI 71 is a user interface presenting the preceding image acquired in the preceding reading process (Step S 113) to the user. In this example, the preceding image display section 715 is provided in the lower part of the input button 704 receiving the designation of the 2-line lighting mode from the user.

Returning to the description of FIG. 8, after the mode designation receiving process (Step S114), the personal computer 20 selects (Step S115) any one of the 1-line lighting mode and the 2-line lighting mode based on an instruction input from the user in the mode designation receiving process (Step S114) by the CPU 210 operating as the mode selecting unit 814.

When the 1-line lighting mode is selected (Step S115: “A”), the personal computer 20 executes a 1-line lighting controlling process (Step 5116) by the CPU 210 operating as the first mode unit 811. The 1-line lighting controlling process (Step 5116) in the first modified example is the same as the 1-line lighting controlling process (Step 5106) in the embodiment described above. After the 1-line lighting controlling process (Step S116), the personal computer 20 acquires image data obtained by reading the original 90 in the 1-line lighting mode from the image scanner 10 and retains the data in the storing device 220 (Step S118).

On the other hand, when the 2-line lighting mode is selected (Step S 115: “B”), the personal computer 20 prepares image data expressing the preceding image that has been acquired in the 2-line lighting mode in the preceding reading process (Step S 113) as a retention target (Step S 117). After that, the personal computer 20 retains the image data acquired in the 2-line lighting mode in the preceding reading process (Step S 113) in the storing device 220 (Step S118).

According to the image reading system 1 in the first modified example described above, it is possible to adjust the influence of the surface shape in the original 90 on the read image by switching the mode of lighting by the lighting devices 40a and 40b irradiating the original 90 as the user wants. In addition, since the GUI 71 is provided with the preceding image display section 715 displaying the preceding image by the 2-line lighting mode, the user can select a lighting mode with reference to the preceding image obtained by reducing the influence of the wrinkled or irregular surface shape of the original 90. In addition, when the 2-line lighting mode is selected (Step 5115: “B”), the preceding image that has been acquired in the 2-line lighting mode in the preceding reading process (Step S 113) is used, and therefore, it is possible to promote improvement of a processing speed.

### B2. Second Modified Example

The structure of an image reading system 1 according to a second modified example is the same as that in the embodiment described above. The operation of the image reading system 1 according to the second modified example is the same as that in the embodiment described above except that the image reading controlling process executed by the personal computer 20 is different from each other.

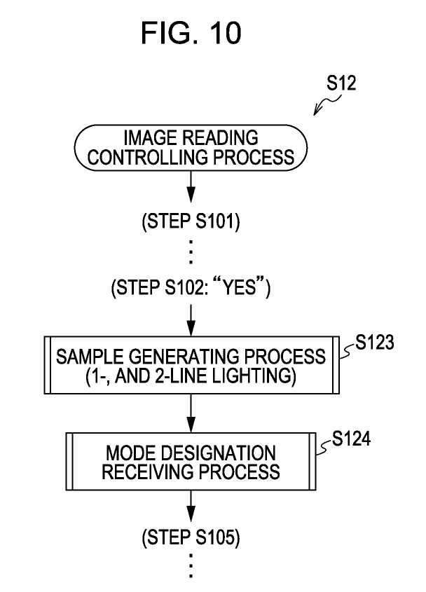

FIG. 10 is a flowchart illustrating an image reading controlling process (Step S12) executed by the personal computer 20 of the image reading system 1 in the second modified example. The image reading controlling process (Step S12) is a process of controlling the operation of the image scanner 10. In this example, the personal computer 20 executes the image reading controlling process (Step S12) by the CPU 210 operating as the image reading controlling section 810 based on the scanner driver 284.

The image reading controlling process (Step S12) in the second modified example is the same as the image reading process (Step S10) in the embodiment described above except that a sample generating process (Step S 123) and a mode designation receiving process (Step S 124) are executed instead of the mode designation receiving process (Step S 104) in the embodiment described above.

In the image reading controlling process (Step S12) in the second modified example, when there is a start instruction (Step S 102: “YES”), the personal computer 20 executes a sample generating process (Step S 123) of generating a sample image expected when the original 90 is optically read in each of the 1-line lighting mode and the 2-line lighting mode.

In this example, in the sample generating process (Step S 123), the personal computer 20 acquires two pieces of image data obtained by reading part of the original 90 in each of the 1-line lighting mode and the 2-line lighting mode from the image scanner 10 by transmitting controlling data for reading part of the original 90 in each of the 1-line lighting mode and the 2-line lighting mode to the image scanner 10. In this example, the sample image in the 1-line lighting mode is an image obtained by reading part of the original 90 in the 1-line lighting mode using the lighting device 40a which is the former line lighting, but in other embodiments, the sample image may be an image obtained by reading part of the original 90 in the 1-line lighting mode using the lighting device 40b which is the latter line lighting, and may be two sample images by the 1-line lighting mode using both of the lighting devices 40a and 40b.

After the sample generating process (Step S 123), the personal computer 20 executes a mode designation receiving process (Step S 124). In the mode designation receiving process (Step S 124), the personal computer 20 receives an instruction from a user by which mode the original 90 is to be read between the 1-line lighting mode and the 2-line lighting mode. In this example, in the mode designation receiving process (Step S 124), the personal computer 20 receives an instruction of a mode from a user through a GUI.

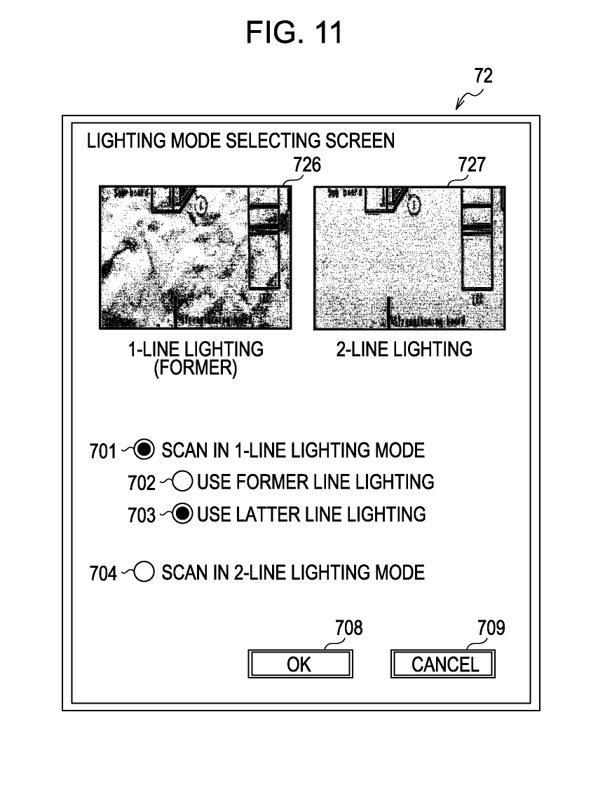

FIG. 11 is an explanatory diagram illustrating an example of a GUI 72 presented to a user in the mode designation receiving process (Step S 124) according to the second modified example. The GUI 72 in the second modified example is the same as the GUI 70 in the embodiment described above except that the GUI 72 is provided with sample image display parts 726 and 727 for displaying sample images generated in the sample generating process (Step S 123). The sample image display part 726 of the GUI 72 is a user interface presenting a sample image obtained by reading part of the original 90 in the 1-line lighting mode toward the user, and the sample image display part 727 of the GUI 72 is a user interface presenting a sample image obtained by reading part of the original 90 in the 2-line lighting mode toward the user. In this example, the sample image display parts 726 and 727 are orderly placed in left and right in the upper portion of the GUI 72.

Returning to the description of FIG. 10, after the mode designation receiving process (Step S124), the personal computer 20 selects any one of the 1-line lighting mode and the 2-line lighting mode based on an instruction input from the user in the mode designation receiving process (Step S 124) by the CPU 210 operating as the mode selecting unit 814 (Step S115). Processes thereafter are the same as those in the image reading process (Step S10) in the embodiment described above.

According to the image reading system 1 in the second modified example described above, it is possible to adjust the influence of the surface shape in the original 90 on the read image by switching the mode of lighting by the lighting devices 40a and 40b irradiating the original 90 as the user wants. In addition, since the GUI 72 is provided with the sample image display parts 726 and 727 for displaying each of sample images in each of the 1-line lighting mode and the 2-line lighting mode, the user can select a mode comparing the sample images in each of the modes with each other.

### B3. Third Modified Example

The structure and the operation of an image reading system 1 according to the third modified example is the same as those in the embodiment described above except that the GUI presented to the user in the mode designation receiving process (Step S 104) is different.

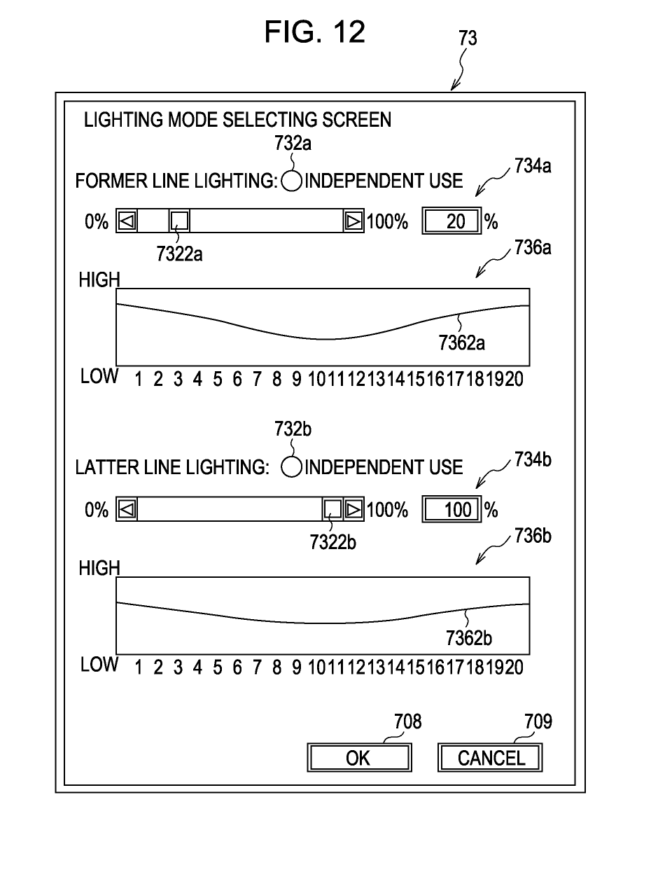

FIG. 12 is an explanatory diagram illustrating an example of a GUI 73 presented to the user in the mode designation receiving process (Step S104). In the personal computer 20, the GUI 73 is displayed in the display 252 and receives an instruction input from the user via the mouse 256. The GUI 73 is provided with input buttons 732a and 732b, light amount adjusting parts 734a and 734b, light distribution adjusting parts 736a and 736b, an execution button 708, and a cancel button 709.

The input button 732a of the GUI 73 is a user interface receiving an instruction of the 1-line lighting mode using the lighting device 40a which is the former line lighting from the user, and the input button 732b of the GUI 73 is a user interface receiving an instruction of 1-line lighting mode using the lighting device 40b which is the latter line lighting from the user. In this example, the input buttons 732a and 732b are switched into black circles or white circles by clicking them with the mouse 256, and the black circles represent a selected state and the white circles represent a non-selected state. In this example, the input buttons 732a and 732b are in either state where one of the buttons turns into a black circle and the other one turns into a white circle or where both of the buttons turn into white circles, and when both of the buttons are white circles, the 2-line lighting modes is set to be selected.

The light amount adjusting part 734a of the GUI 73 is a user interface receiving the adjustment of a light amount in which light is irradiated from the lighting device 40a which is the former line lighting from the user, and the light amount adjusting part 734b of the GUI 73 is a user interface receiving the adjustment of a light amount in which light is irradiated from the lighting device 40b which is the latter line lighting from the user. In this example, the light amount adjusting parts 734a and 734b are provided with scales 7342a and 7342b indicating each of light amount of the lighting devices 40a and 40b. The user can adjust individual light amounts of the lighting devices 40a and 40b from 0% of a light-out state to 100% of the maximum light amount by dragging and moving each of the scales 7342a and 7342b with the mouse 256.

The light distribution adjusting part 736a of the GUI 73 is a user interface receiving the adjustment of light amount in which light is emitted from each of the plurality of light emitting elements 422a provided in the lighting device 40a which is the former line lighting from the user, and the light distribution adjusting part 736b of the GUI 73 is a user interface receiving the adjustment of light amount in which light is emitted from each of the plurality of light emitting elements 422b provided in the lighting device 40b which is the latter line lighting from the user. In this example, the light distribution adjusting parts 736a and 736b are provided with curves 7362a and 7362b indicating each of distributions of light amount in the plurality of light emitting elements 422a and 422b by smoothly connecting the light amount in which light is emitted from the light emitting elements 422a and 422b and the light amount in which light is emitted from other adjacent light emitting elements 422a and 422b. The user can individually adjust the division of light distributed on the long surfaces 432a and 432b in the lighting devices 40a and 40b by dragging the curves 7362a and 7362b up and down to modify the curves at an arbitrary spot.

According to the image reading system 1 in the third modified example described above, it is possible to adjust the influence of the surface shape in the original 90 on the read image by switching the condition of lighting by the lighting devices 40a and 40b irradiating the original 90 as the user wants. In addition, since the GUI 73 is provided with the light amount adjusting parts 734a and 734b receiving the adjustment of light amount in which light is emitted from the lighting devices 40a and 40b from the user, and the light distribution adjusting parts 736a and 736b receiving the adjustment of light amount in which the light is emitted from the plurality of light emitting elements 422a provided in the lighting device 40a from the user, the user can adjust the influence of the surface shape of the original 90 on the captured image.

### C. Other Embodiment

Hereinabove, embodiments of the invention have been described, but the invention is not limited to the embodiments, and can be implemented in various forms within the scope not departing from the gist of the invention.

For example, the image reading controlling process executed by the personal computer 20 may be performed by using the main controlling section 150 and the user interface 190 in the image scanner 10.

Furthermore, in the embodiment above, an example that the invention is applied to the flat bed type image scanner 10 has been described, but in other embodiments, the invention may be applied to an image scanner with other types such as an automatic document feeding type, a handy type, a drum type or the like, and in addition to them, can be applied to a document reading apparatus such as a fax machine, a copy machine, a multifunctional machine or the like.

What is claimed is:

1. A controlling device for controlling an image reading apparatus that optically reads an original, comprising:
a lighting controlling section that controls a first lighting section and a second lighting section which are the first and second lighting sections provided in the image reading apparatus, form each of the linear light emitting regions, and irradiate the original with light from directions intersecting with each other,
wherein the lighting controlling section includes a first mode unit that controls the first and second lighting sections in a first mode in which one of the first and second lighting sections irradiates the original, a second mode unit that controls the first and second lighting sections in a second mode in which both of the first and second lighting sections irradiate the original, and a mode selecting unit that selects any one of the first mode or second mode based on an instruction input from a user when the original is optically read.

2. The controlling device according to claim 1, wherein the mode selecting unit further includes a preceding reading section that acquires a preceding image obtained by optically reading the original in the second mode before the mode selecting unit selects any one of the first mode or second mode, and a first user interface that presents the preceding image to a user and receives an instruction input from the user for selecting any one of the first mode or second mode.

3. The controlling device according to claim 1, wherein the mode selecting unit further includes a second user interface that receives an instruction input from the user for adjusting at least one of an amount of light emitted from each of the first and second lighting sections, and division of light distributed in light emitting regions in each of the first and second lighting sections.

4. The controlling device according to claim 1, wherein the mode selecting unit further includes a third user interface that presents a sample image expected when the original is optically read in each of the first and second modes to the user.

5. An image reading apparatus for optically reading an original, comprising:
first and second lighting sections that form each of the linear light emitting regions and irradiate the original with light from directions intersecting with each other; and
a lighting controlling section that includes a first mode unit that controls the first and second lighting sections in a first mode in which one of the first and second lighting sections irradiates the original, a second mode unit that controls the first and second lighting sections in a second mode in which both of the first and second lighting sections irradiate the original, and a mode selecting unit that selects any one of the first mode or second mode based on an instruction input from a user when the original is optically read.

6. A controlling method for controlling an image reading apparatus that optically reads an original, comprising:
lighting controlling by a computer which controls a first lighting section and a second lighting section that are the first and second lighting sections provided in the image reading apparatus, form each of the linear light emitting regions, and irradiate the original with light from directions intersecting with each other, wherein the lighting controlling includes selecting any one of a first mode in which one of the first and second lighting sections irradiates the original or a second mode in which both of the first and second lighting sections irradiate the original based on an instruction input from a user.
